(19) United States
(12) Patent Application Publication
(10) Pub. No.: US 2020/0005380 A1
(43) Pub. Date: Jan. 2, 2020

(54) SYSTEM AND METHOD FOR IDENTIFYING OPTIONAL EQUIPMENT ON PREOWNED VEHICLES

(71) Applicant: Optionguard LLC, Atlanta, GA (US)

(72) Inventors: Austin Brode HOWARD, Atlanta, GA (US); Craig Pepper Yandell, Dallas, TX (US)

(73) Assignee: Optionguard LLC, Atlanta, GA (US)

(21) Appl. No.: 16/457,307

(22) Filed: Jun. 28, 2019

Related U.S. Application Data
(60) Provisional application No. 62/698,425, filed on Jul. 16, 2018.
(60) Provisional application No. 62/692,080, filed on Jun. 29, 2018.

(51) Int. Cl. G06Q 30/06; G06F 16/955

(52) U.S. Cl. CPC G06Q 30/0627; G06Q 30/0621; G06F 16/955

(57) ABSTRACT

Optional equipment on preowned vehicles is provided by a database storing unique identifier data for each one of the preowned vehicles and storing optional equipment data for each one of the preowned vehicles and associated with the corresponding unique identifier data for the corresponding preowned vehicle, and a software application for a computer device with communications components for connecting to a communications network, the software application operable to receive an inputted unique identifier data of a selected preowned vehicle, operate the computer device to access the database and retrieve the optional equipment data corresponding to the inputted unique identifier data, and output the retrieved optional equipment data for use for example by printing it on a window sticker.

### CROSS-REFERENCE TO RELATED APPLICATIONS

This application claims the priority benefit of U.S. Provisional Patent Application Ser. No. 62/698,425, filed Jul. 16, 2018, and U.S. Provisional Patent Application Ser. No. 62/692,080, filed Jun. 29, 2018, which are hereby incorporated herein by reference.

### TECHNICAL FIELD

The present invention relates generally to vehicle sales systems, and particularly to such systems for providing vehicle-specific information in the preowned-vehicle industry.

### BACKGROUND

In the automotive/transportation industries, when consumers purchase a new vehicle (car, truck, motorcycle, boat, etc.), they often select “options” for additional costs to customize their purchase. For example, a consumer may choose a “Rear Seat Entertainment Package” option on a new car. When later reselling the vehicle, it's helpful for valuation of the vehicle to know what optional features it has. But currently there is no efficient way for a private consumer or preowned-vehicle dealer to ascertain what optional features are included on a vehicle in the resale market. Typically, preowned-vehicle dealers must call or email the manufacturer for this, with it typically taking a lot of time and effort to get this information. And private consumers typically must contact a manufacturer-licensed franchise dealer and have them research this with the manufacturer.

Accordingly, it can be seen that needs exist for a better way to ascertain the optional features on preowned vehicles. It is to the provision of solutions meeting these and other needs that the present invention is primarily directed.

### SUMMARY

Generally described, the present invention relates to providing optional equipment on preowned vehicles by a database storing unique identifier data for each one of the preowned vehicles and storing optional equipment data for each one of the preowned vehicles and associated with the corresponding unique identifier data for the corresponding preowned vehicle, and a software application for a computer device with communications components for connecting to a communications network, the software application operable to receive an inputted unique identifier data of a selected preowned vehicle, operate the computer device to access the database and retrieve the optional equipment data corresponding to the inputted unique identifier data, and output the retrieved optional equipment data for use for example by printing it on a window sticker.

The specific techniques and structures employed to improve over the drawbacks of the prior art and accomplish the advantages described herein will become apparent from the following detailed description of example embodiments and the appended drawings and claims.

### BRIEF DESCRIPTION OF THE DRAWINGS

FIG. 1 is a block diagram of a system for identifying existing non-standard features of preowned vehicles according to an example embodiment of the invention.

FIG. 2 is a flow diagram of a method for identifying existing non-standard features of preowned vehicles according to an example embodiment of the invention.

### DESCRIPTION OF EXAMPLE EMBODIMENTS

The present invention relates to a system and method for identifying optional features on preowned vehicles. The option-identification system and method can be used for a range of different type of vehicles, including but not limited to cars, trucks, motorcycles, scooters, mopeds, towed vehicles, boats, personal watercraft, and the like. And the option-identification system and method can be used for identifying a range of different type of optional features, including but not limited to safety features such as blind-spot monitoring and forward-collision warning systems, comfort features such as upgraded seats and upgraded sound systems, and technology features such as voice controls and heads-up displays. As used herein, such optional features are sometimes referred to synonymously as options and as non-standard features.

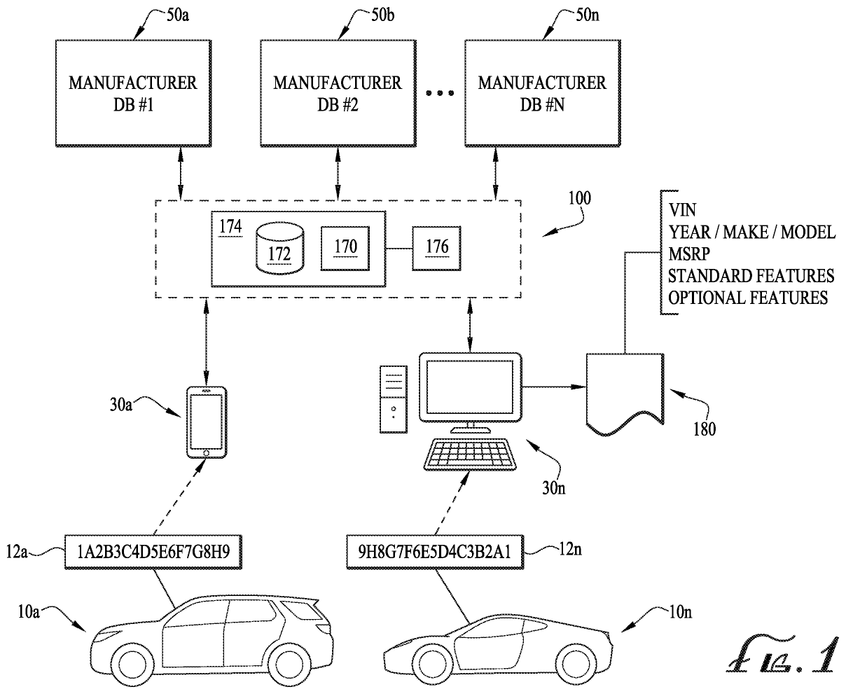

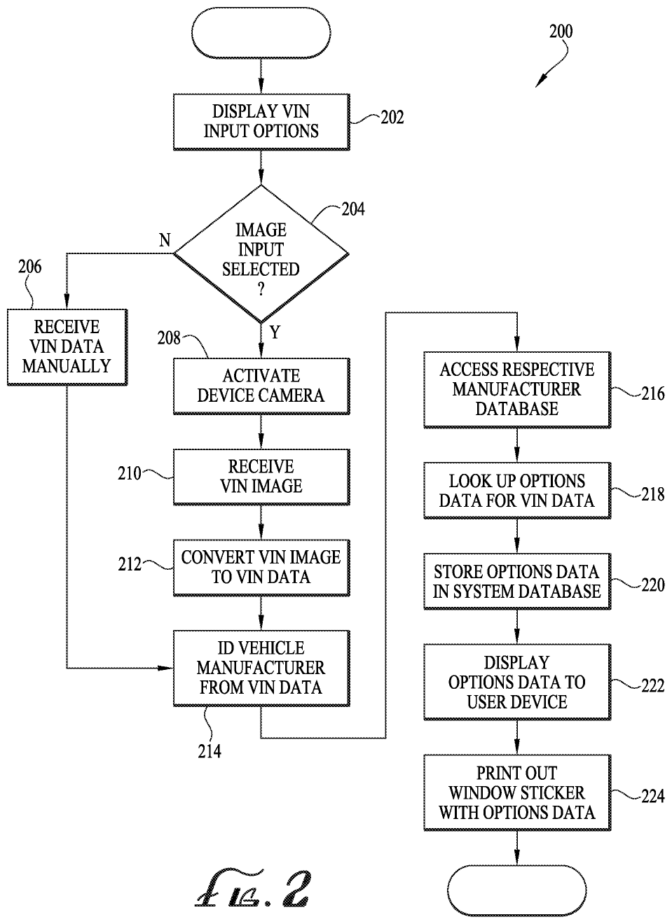

Turning now to the drawings, FIGS. 1-2 show a system 100 and method 200 for identifying existing non-standard features of preowned vehicles 10 according to an example embodiment of the invention. Referring specifically to FIG. 1, the system 100 is for use with any vehicle category in which each vehicle 10 has a unique identifier 12 such as a character string (numerals and/or letters) and/or a barcode (e.g., a binary representation of the character string). In the depicted embodiment, for example, the vehicles are an SUV 10a and a sports car 10n (vehicles 10a-n are collectively referred to herein as the vehicles 10) that each have a vehicle identification number (VIN) 12a and 12n, respectively (identifiers 12a-n are collectively referred to herein as the identifiers 12). The VIN 12 can be in the form of a 17-character string (as depicted) and/or a barcode, typically stamped into a metal plate or printed onto a sticker and typically located on the driver's side dashboard (adjacent and under the front windshield) or on the driver's side door or door jamb. In other embodiments, the vehicles include boats and/or other watercraft that have unique identifiers in the form of hull identification numbers (HINs) and/or other vehicles that are commonly purchased with selected optional features, commonly resold, and include unique identifiers (e.g., serial numbers or other identification numbers), such as aircraft and bicycles.

In addition, the system 100 is for use with any number of user electronic devices 30 including conventional processing components (e.g., micro-processors, data-storage devices, and programming), communications components (e.g., transceivers and antennas, and/or wired connections), and input/output devices (e.g., keypads/keyboards, pointing devices, touch screens, and/or display screens). In the depicted embodiment, for example, the user devices are a camera-equipped smartphone 30a and a desktop computer 30n (electronic devices 30a-n are collectively referred to herein as the user devices 10). In other embodiments, the user devices include laptop computers, tablet computers, PDAs, and/or other computer-processor devices adapted to provide the functionality described herein.

The system 100 communicates with a plurality of vehicle-information databases 50 of individual manufacturers of the vehicles. For example, database 50a can include data for LEXUS vehicles, database 50b can include data for MERCEDES-BENZ vehicles, etc., through database 50n including data for LAND ROVER vehicles (databases 50a-n are collectively referred to herein as the databases 50). The vehicle-information databases 50 include options data for each corresponding vehicle identifier and typically include additional vehicle data such as MSRP, standard features, base prices for standard and options features, and so forth. The options data in the vehicle-information databases 50 represents the selected optional features on each corresponding vehicle, with the options being installed at the factory by the manufacturer for the initial sale of the vehicle (though optionally aftermarket options can be included).

The vehicle-information databases 10 are typically owned and maintained by the individual vehicle manufacturers, but alternatively they can be maintained by other party. As such, the vehicle-information databases 10 are typically all remotely and separately located at places chosen by the vehicle manufacturers. In another embodiment, the options data is combined into a single collective database owned and maintained by the system 100 administrator or a third party (this can be the same database 172 described below or a different one).

The system 100 communicates with the vehicle-information databases 50 by a conventional networked communications system such as the internet and/or a cellular network. In typical embodiments, the system 100 accesses a selected one of the vehicle-information databases 50 to obtain the options data for a selected vehicle identifier on an individual as-need basis. The manufacturers gain the advantage of their vehicles doing better in the resale market, and in some embodiments can additionally be compensated on a per-use basis, a regular (e.g., monthly or annual) subscription, etc.

The system 100 includes a software program 170 and a database 172 stored on a non-transitory memory storage device 174 and a processor 176 for executing the instruction sets of the software program. The software program 170 and the database 172 can be located on the same storage device 174 or they can be stored in a distributed arrangement on a number of different storage devices for example on a network of cloud-based servers. Similarly, the processor 176 can be located together with or remotely from the software program 170 and the database 172. The system 100 also includes communications components for communicating with the user electronic devices 30 and the vehicle-information databases 50 via the internet and/or a cellular network. The system 100 further includes other conventional features and components for security and other purposes as are common in networked computer systems. The database 172, storage device 174, processor 176, communications components, and other components and features can be of a conventional type well known in the art of information technology.

Details of the software program 170 and the operation of the system 100 will now be described with reference to FIG. 2, which shows the method 200 for identifying existing non-standard features of preowned vehicles 10 according to another aspect of the invention. The software program 170 typically includes common components and features for example for registering new users (via the user devices 30), saving user ID data (on the system database 172), processing payments by new/renewing users (via the user devices 30), saving (on the system database 172) and displaying (via the user devices 30) user history, and so forth. Such components and features are well known in the information-technology field, so for brevity they are not detailed herein.

The software program 172 can be implemented as a mobile app and/or as a website for accessing and using via the user devices 30. When implemented as a website, particularly for use by desktop and laptop computers but also for use by tablet computers and smartphones, the software program 172 resides on the storage device 174 remote from the user devices 30, and is typically mobile optimized. When implemented as a mobile app, for use by camera-equipped smartphones and tablet computers, an app component (including a mobile interface) of the software program 172 is downloaded onto the user devices 30 (e.g., APPLE and/or ANDROID devices). For convenience, the system 100 and method 200 will be described with primary reference to a mobile app implementation used by user with a smartphone 30a.

Upon launching the software program 172, the method 200 starts at 202 by displaying options to the corresponding smartphone user device 30a for the user to input the VIN data using an input device of the user device. The displayed options can be for the user to manually enter the VIN using the keypad or touchscreen of the smartphone 30a or to optically enter the VIN using the camera of the smartphone 30a. For example, manual or optical input icons/buttons can be displayed for the user to select, or for the manual-input option a blank field can be displayed for the user the type in the VIN.

If at 204 the user selects the manual option, then at 206 the VIN data is received from the smartphone 30a by the user manually typing in the VIN. The method then proceeds ahead to step 214.

If however at 204 the user selects the optical option, then at 208 the camera of the smartphone 30a is activated. In some embodiments, the software program includes programming for controlling the camera, and in other embodiments the existing camera app of the smartphone 30a is used to control the camera. Next, at 210 an image of the VIN is received from the camera of the smartphone 30a by the user holding the camera facing the VIN plate or sticker. Then at 212 the VIN image is converted to the VIN data. For example, the software program 172 can include (or access an existing app including) programming for optical character recognition (OCR) that converts the VIN image of a character string into the VIN data representing the character string. Additionally or alternatively, the software program 172 can include (or access an existing app including) programming for barcode scanning that converts the VIN image of a barcode into the VIN data representing the character string.

The VIN data has now been received, either manually or optically. It should be noted that in some embodiments, the method 200 excludes the VIN input option steps 202 through 204 and the optical input steps 208 through 212, and instead starts with receiving the manually input VIN at step 206 then proceeds directly to step 214. For example, such embodiments can include web-enabled implementations that are not mobile optimized and thus that are not intended for use on camera-equipped mobile user devices.

At 214, the vehicle manufacturer is identified from the VIN, and at 216 the corresponding vehicle-information database 50 is accessed. The standard format for VINs includes a world manufacturer identifier (WMI) designating each vehicle manufacturer, so the manufacturer for the corresponding vehicle is determined by identifying the WMI in the VIN. So for a LEXUS SUV, the WMI of the inputted VIN is a designation for LEXUS, and so the system 100 then proceeds to access the LEXUS database 50a (not the MERCEDES-BENZ database 50b or the LAND ROVER database 50n). In embodiments in which the options data is combined into a single collective database, the step 214 of identifying the manufacturer is not included in the method and the step 216 of accessing the corresponding manufacturer's database includes simply accessing the collective database. And in other embodiments, the method 200 includes an added step of displaying to the user device 30 an input feature for designating the manufacturer (e.g., a scroll-down menu of manufacturers) and the step 214 of identifying the manufacturer includes receiving from the user device a designation of the manufacturer (instead of determining that from the VIN).

Then at 218 the options data corresponding to the inputted VIN is looked up on and retrieved from the corresponding vehicle-information database 50a. The retrieved options data is typically stored on the system database 172 for future use (without having to again access the manufacturer's vehicle-information database 50a) at 220 and sent to the smartphone 50a for displaying to the user at 222. In some embodiments, addition vehicle-related information is retrieved from the vehicle-information database 50a then stored and displayed, for example the standard features on the vehicle, the base price, and the options price, and the total MSRP.

In addition, the method can include at 224 the step of sending the options data to a conventional printer (not shown) for printing out a window sticker 180 listing the optional features. The optional features and the other information (VIN, year-make-model of the vehicle, standard features, base price, optional features, options price, total MSRP, and so forth) on the window sticker can be selected and formatted so that the window sticker has the appearance of a conventional window sticker for vehicle transactions. The specific information included on the window stickers 180 is selected and formatted to comply with all rules and regulations in the industry.

In typical embodiments, there are two types of user accounts: a consumer account and a dealer account. For example, both accounts can access the same system database 172 and use the same interface on the website, however dealer accounts can additionally have access to downloading and using the mobile app. Also, consumer accounts can pay a one-time fee for a single use of the system 100 and method 200. Dealer accounts can do the same, but are typically on a monthly subscription basis and receive unlimited use of the system 100 and method 200. Both consumer and dealer accounts store (on the system database 172) all previously received VIN data and options data for later accessing without having to re-enter the VIN data.

It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

While the invention has been described with reference to example embodiments, it will be understood by those skilled in the art that a variety of modifications, additions, and deletions are within the scope of the invention, as defined by the following claims.

What is claimed is:

1. A system for identifying optional equipment on preowned vehicles, comprising:
a database storing unique identifier data for each one of the preowned vehicles and storing optional equipment data for each one of the preowned vehicles and associated with the corresponding unique identifier data for the corresponding preowned vehicle; and
a software application for a computer device with communications components for connecting to a communications network, wherein the software application is operable to receive an inputted unique identifier data of a selected preowned vehicle, operate the computer device to access the database and retrieve the optional equipment data corresponding to the inputted unique identifier data, and output the retrieved optional equipment data for use.

2. The system of claim 1, wherein the unique identifier data includes VINs, barcodes corresponding to VINs, or a combination thereof.

3. The system of claim 1, wherein the computer device is a smartphone or a desktop, laptop, or tablet computer.

4. The system of claim 1, wherein the retrieved optional equipment data is output to a printer, to a display screen of the computer device, or both.

5. The system of claim 1, wherein the inputted unique identifier data is input by manual typing, scanning, or photographing.

6. A method for identifying optional equipment on preowned vehicles, comprising:
receiving an inputted unique identifier data of a selected preowned vehicle;
accessing a database and retrieving optional equipment data corresponding to the inputted unique identifier data; and
outputting the retrieved optional equipment data for use.

7. The method of claim 6, wherein the outputting step includes printing a vehicle window sticker displaying the retrieved optional equipment data.

8. A non-transitory storage device storing computer-readable instructions for implementing the method of claim 6.
